(19) United States
(12) Patent Application Publication
(10) Pub. No.: US 2010/0303445 A1
(43) Pub. Date: Dec. 2, 2010

(54) Audio/Video Content Reproducing Apparatus

(75) Inventors: Hirochika MAEGAKI, Hamamatsu-shi (JP); Yuki YOSHIZAWA, Hamamatsu-shi (JP)

Correspondence Address: CROWELL & MORING LLP;INTELLECTUAL PROPERTY GROUP, P.O. BOX 14300, WASHINGTON, DC, 20044-4300, US

(73) Assignee: Yamaha Corporation, Hamamatsu-shi (JP)

(21) Appl. No.: 12/787,830

(22) Filed: May 26, 2010

(30) Foreign Application Priority Data
May 26, 2009 (JP) 2009-127076

(51) Int. Cl. H04N 5/91

(52) U.S. Cl. 386/248

(57) ABSTRACT

An audio/video content reproducing apparatus includes: a plurality of connecting sections to be connected to respective source devices for reproducing plural types of contents whose watching/listening modes are different from each other; a watching/listening mode table for storing the watching/listening modes of the contents that the respective source devices can reproduce; a watching/listening mode selecting section that is configured to accept the user's choice of the watching/listening mode; a source device extracting section that is configured to extract at least one source device that can reproduce the contents in the selected watching/listening mode, with reference to the watching/listening mode table; a source device selecting section that is configured to accept the user's choice of the source device out of the at least one extracted source device; and a content reproducing section that is configured to output the content which the selected source device can reproduce in the selected watching/listening mode.

### BACKGROUND OF THE INVENTION

1. Technical Field

The present invention relates to an audio/video content reproducing apparatus that reproduces the content of the connected source device.

2. Background Art

The custom installation used to construct the AV system by freely combining a plurality of AV (Audio/Video) devices is widely adopted. In the custom installation, in order to select freely the desired content out of a wide variety of audio/video contents from a plurality of connected source devices and reproduce it, the AV receiver is employed (Non-Patent Literature 1, for example).

Non-Patent Literature 1: Yamaha Corporation of America, “RX-V/RX-Z/RX-N Series, AV Receivers from Yamaha Electronics”, [online], 2009, Yamaha Corporation of America, [May 15, 2009 searched], Internet <URL: www.yamaha.com/yec/products/product/detail.html?CNTID=558249&CTID=5000300>

In the recent AV receiver, not only a common STB (Set-Top Box), a DVD (BD) player, a VCR (Video Cassette Recorder) deck, and the like are connected as the conventional source device, but also memory devices such as a portable player, a USB memory, a personal computer (HDD), and the like, which can store a wide variety of contents in large numbers, can be connected as the source device.

The conventional source devices are not so multifunctional, and the types of reproducible contents are fixed respectively. For example, the STB is used to watch the television broadcast, the DVD player is used to play the DVD (video contents) or listen the CD (audio contents), the VCR is used to play the video cassette (video contents), and others. On the contrary, the new type of source device can store freely a wide variety of contents. In many cases, the contents such as audio contents, video contents or photo albums, and the like are stored together. Therefore, in the background art, when the user reproduces the content in the new type of source device, such user has to search the desired one from plural types of mixed contents and this searching is providing troublesome to the user.

Also, as described above, a great variety of source devices can be connected to the recent AV receiver. As a result, when the user wants to reproduce the particular type of contents (e.g., video contents), it is difficult for the user to understand what type of source device should be selected.

### SUMMARY OF THE INVENTION

It is an object of the present invention to provide an audio/video content reproducing apparatus capable of searching easily a desired content even when a large number of source devices are connected or when a source device that stores a wide variety of contents is connected to the apparatus.

According to a first aspect of the present invention, there is provided an audio/video content reproducing apparatus, including: a plurality of connecting sections to be connected to respective source devices, each device including a content reproducing section for reproducing at least a part of plural types of contents whose watching/listening modes are different from each other, a watching/listening mode table for storing the watching/listening modes of the contents that the respective source devices can reproduce; a watching/listening mode selecting section that is configured to accept the user's choice of the watching/listening mode; a source device extracting section that is configured to extract at least one source device that can reproduce the contents in the selected watching/listening mode, with reference to the watching/listening mode table; a source device selecting section that is configured to accept the user's choice of the source device out of the at least one extracted source device; and a content reproducing section that is configured to output the content which the selected source device can reproduce in the selected watching/listening mode.

The audio/video content reproducing apparatus may be configured in that the content reproducing section includes: a content extracting section that is configured to extract only the contents in the selected watching/listening mode out of the contents that the selected source device can reproduce; and a content selecting section that is configured to accept the user's choice of the content out of the extracted contents.

The audio/video content reproducing apparatus may be configured in that the watching/listening modes include Listen mode, Watch mode and Play mode.

According to a second aspect of the present invention, there is provided an audio/video content reproducing apparatus, including: a plurality of connecting sections to be connected to respective source devices, each device including a content storing section for storing therein at least a part of plural types of contents whose watching/listening modes are different from each other, a watching/listening mode table for storing the watching/listening modes of the contents stored in the respective source devices; a watching/listening mode selecting section that is configured to accept the user's choice of the watching/listening mode; a source device extracting section that is configured to extract at least one source device that stores the contents in the selected watching/listening mode, with reference to the watching/listening mode table; a source device selecting section that is configured to accept the user's choice of the source device out of the at least one extracted source device; and a content reproducing section that is configured to output the content stored in the selected source device in the selected watching/listening mode.

According to a third aspect of the present invention, there is provided an audio/video content reproducing apparatus, including: a plurality of connecting sections to be connected to respective source devices, each device including a content reproducing section for reproducing at least a part of plural types of contents whose watching/listening modes are different from each other, a watching/listening mode selecting section that is configured to accept the user's choice of the watching/listening mode; a content extracting section that is configured to extract only the contents in the selected watching/listening mode out of the contents that the source devices can reproduce; a content selecting section that is configured to accept the user's choice of the content out of the extracted contents; and a content reproducing section that is configured to output the selected content in the selected watching/listening mode.

According to a fourth aspect of the present invention, there is provided an audio/video content reproducing apparatus, including: a plurality of connecting sections to be connected to respective source devices, each device including a content storing section for storing therein at least a part of plural types of contents whose watching/listening modes are different from each other, a watching/listening mode selecting section that is configured to accept the user's choice of the watching/listening mode; a content extracting section that is configured to extract only the contents in the selected watching/listening mode out of the contents stored in the source devices; a content selecting section that is configured to accept the user's choice of the content out of the extracted contents; and a content reproducing section that is configured to output the selected content in the selected watching/listening mode.

According to the present invention, even when a large number of source devices are connected to the audio/video content reproducing apparatus, the user never hesitate to select the source device.

Also, even when the source device that stores a wide variety of contents is connected to the audio/video content reproducing apparatus, the user can search easily the desired contents based on a watching/listening mode.

### BRIEF DESCRIPTION OF THE DRAWINGS

In the accompanying drawings:

FIG. 1 is a configurative view of an AV system containing an AV receiver as an embodiment of the present invention;

FIG. 2 is a block diagram of the AV receiver;

FIG. 3 shows an activity table stored in the AV receiver;

FIG. 4 is a flowchart showing an operation of the AV receiver;

FIGS. 5A to 5C show an example of a screen that the AV receiver displays on a TV; and

FIG. 6 shows a modified example of a screen that the AV receiver displays on the TV.

### DETAILED DESCRIPTION OF THE EXEMPLARY EMBODIMENTS

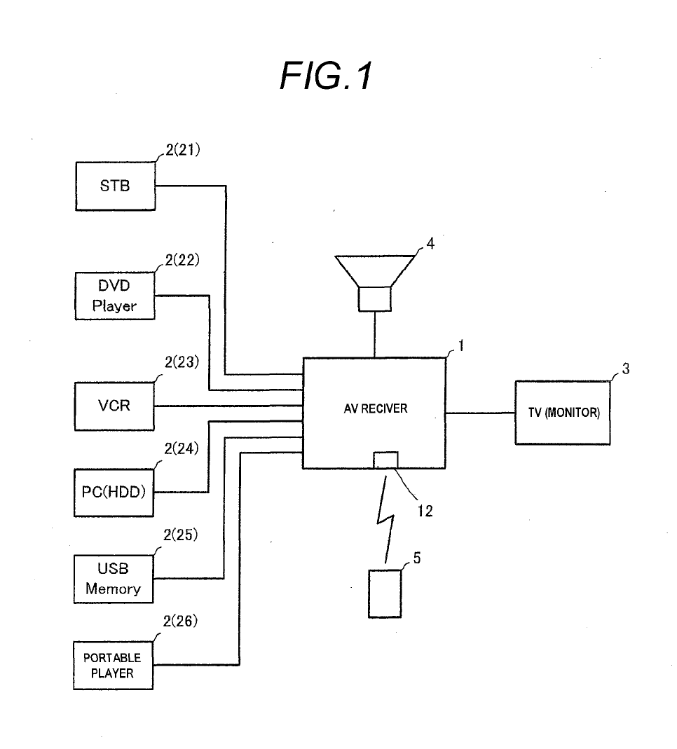

FIG. 1 is a configurative view of an AV system containing an AV receiver as an embodiment of the present invention. This AV system is the so-called custom installation AV system in which a plurality of source devices 2, a TV (monitor) 3, a speaker 4 are connected to an AV receiver 1.

The AV receiver 1 is equipped with a selector function of selecting one device from the plurality of source devices 2, an audio amplifier function of amplifying an audio signal being input from the selected source device 2 and outputting the amplified signal to the speaker 4, a repeater function of outputting the video signal and the audio signal being input from the source devices 2 to the TV 3 on the downstream side, a tuner function of receiving the radio broadcast such as the FM broadcast, or the like, a commander function of controlling the source devices 2 and the TV 3 in response to the user's operation, and the like.

As the source devices 2 connected to the AV receiver 1 as the upstream side devices, there are a STB (set top box) 21, a DVD player 22, a VCR (video cassette recorder) 23, a personal computer (PC) 24, a USB memory 25, a portable player 26, and the like, for example. The STB 21 has a reproducing section for reproducing the television broadcast received via the cable or from the satellite. The DVD player 22 has a reproducing section for reproducing the disc that is set in the player. The VCR 23 has a reproducing section for playing the video cassette that is set in the deck. The PC 24 has a storing medium (HDD) for storing the audio contents, the video contents, etc., and is equipped with a reproducing section of reproducing these contents. The USB memory 25 has a storing medium for storing the contents such as the audio contents, and the like. Also, the portable player 26 has a storing medium (HDD or flash memory) for storing the audio contents, the video contents, etc., and is equipped with a reproducing function of reproducing these contents.

Also, the TV 3 connected as the downstream side device of the AV receiver 1 is used mainly as the monitor that displays the video being input from the AV receiver 1.

Also, the AV receiver 1 has a remote-control signal receiving section 12 that receives the infrared remote-control signal that a remote controller 5 generates.

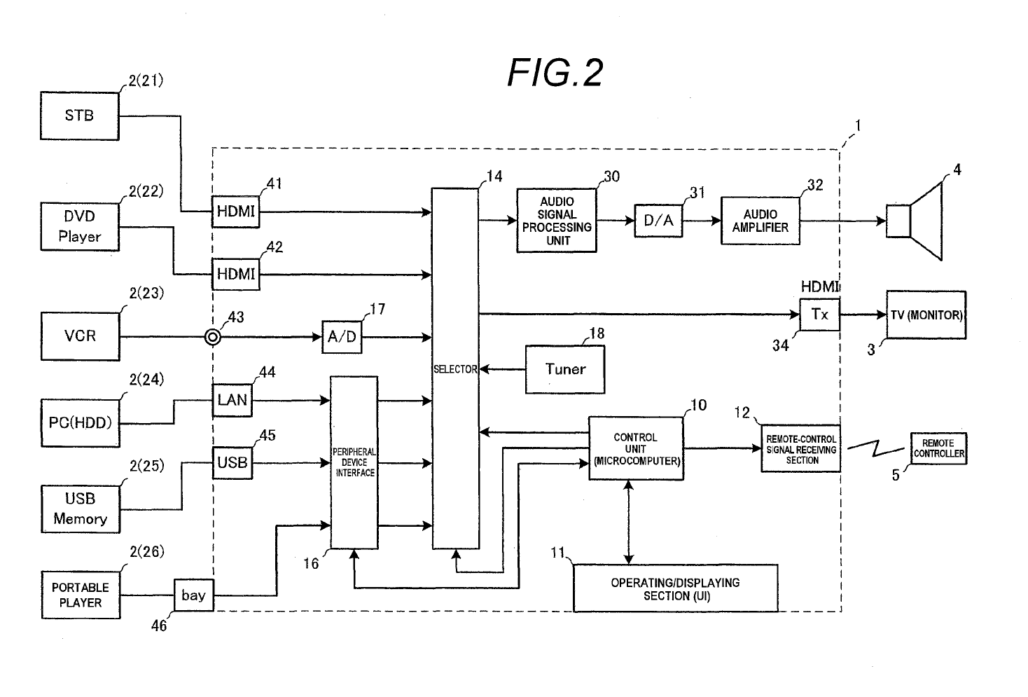

FIG. 2 is a block diagram of the AV receiver 1.

Various connectors used to connect the plurality of source devices 2 are provided to (the back surface of) the AV receiver 1. An HDMI connector 41 to which the STB 21 is connected, an HDMI connector 42 to which the DVD player 22 is connected, an analog connector 43 to which the VCR 23 is connected, a LAN connector 44 used to communicate with the PC 24, a USB connector 45 to which the USB memory 25 is connected, and a bay type connector 46 to which the portable player 26 is connected are provided to the AV receiver 1. The bay type connector 46 for the portable player 26 is provided externally via a cable. Here, it is assumed that respective connectors contain the physical layer of the electric circuit such as the transceiver, or the like.

The HDMI connectors 41, 42 are connected to a selector 14, the analog connector 43 is connected to the selector 14 via an A/D converter 17, and the LAN connector 44, the USB connector 45, and the dedicated bay type connector 46 are connected to the selector 14 via a peripheral device interface 16. Also, a tuner 18 and a control unit 10 are connected to the selector 14 as the built-in source devices. The tuner 18 is the device that receives/reproduces the broadcasting sounds such as the FM broadcast, and the like. The control unit 10 is implemented by a microcomputer. This control unit 10 is equipped with a function of communicating with the PC 24 and the portable player 26 and a function of switching the selector 14, and is also equipped with a function of displaying OSD (On-Screen Display) such as various operation guides, set wizards, etc., and others and acts as the source device in displaying OSD.

The control unit 10 switches the selector 14 in response to the switching operation being input from the remote controller 5 or an operating/displaying section 11, or the like, and selects the source device.

The video signal containing the audio and video signal, only the audio signal, or the video signal containing only the video is input into the selector 14. The selector 14 outputs the audio signal of the selected device to an audio signal processing unit 30, and outputs the video signal of the selected device to an HDMI transmitter 34. The TV 3 is connected to the HDMI transmitter 34 via the HDMI cable.

A tone quality, etc. of the audio signal are adjusted by the audio signal processing unit 30, and the adjusted signal is converted into the analog signal by a D/A converter 31. This analog signal is amplified by an audio amplifier 32, and then is input into the speaker 4. Here, when the audio amplifier 32 is composed of a digital amplifier, the D/A converter 31 is constructed by the circuit that converts the audio signal from the PCM code to the PWM signal.

The remote controller 5 has a power ON/OFF button of the AV receiver 1, and a button for selecting the source device 2. When the user operates the button, the remote controller 5 generates the infrared remote-control signal in response to the operated button. The AV receiver 1 has the remote-control signal receiving section 12 for receiving the infrared signal generated by the remote controller 5. When the remote-control signal receiving section 12 receives the remote-control signal generated by the remote controller 5, it analyzes the command code and input the analyzed result into the control unit 10. The control unit 10 executes the process corresponding to the command, e.g., the switching of the selector 14, based on the command code being input from the remote-control signal receiving section 12.

Here, the classification of contents in the AV receiver 1 and the user's selecting procedures will be explained hereunder. In this AV receiver 1, the contents are classified into “Listen”, “Watch”, and “Play” as three types of groups whose watching/listening mode of the user is different respectively. The term “Listen” shows the content in the watching/listening mode in which the user enjoys the content by listening it with user's own ears, and denotes the audio content. The term “Watch” shows the content in the watching/listening mode in which the user enjoys the content by watching it with user's own eyes, and denotes the video content. Also, the term “Play” shows the content that the user listens with user's own ears or watches with user's own eyes, and the content in the watching/listening mode in which the video and the sound are changed or switched in response to the user's operation, and denotes the game or photo album (image) content, for example. Three watching/listening modes (content types) of “Listen”, “Watch”, and “Play” are called the activities in the AV receiver 1.

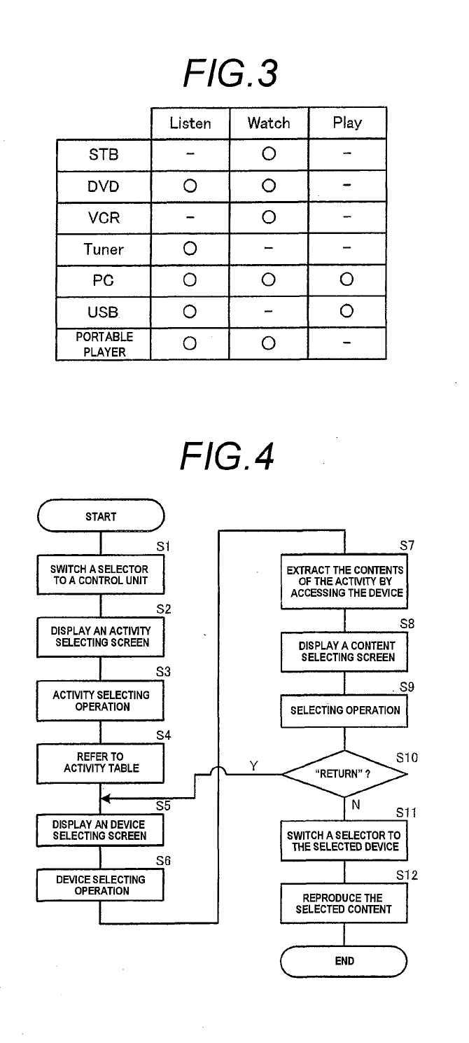

FIG. 3 shows an activity table stored in the AV receiver 1. The activity table is a table in which the activities that respective source devices 2 can reproduce are classified, and is stored in the control unit 10. According to FIG. 3, the activity that the STB 21 for receiving the television broadcast via the cable broadcast or the satellite broadcast can reproduce is “Watch” only. Also, the activity that the DVD player 22 can reproduce is “Watch” and “Listen”. That is, this is because not only the video contents (Watch) of the DVD such as the movie, and the like can be reproduced, but also the music contents (Listen) of the CD can be reproduced. Also, the activity that the VCR deck 23 can reproduce is “Watch” only, and the activity that the tuner 18 can reproduce is “Listen” only. Also, since the PC 24 can accumulate/store all contents of moving images, music, images in the hard disc (HDD), such PC 24 can reproduce all activities of “Listen”, “Watch”, and “Play”. The USB memory 25 can reproduce the music contents (Listen) and the still images (Play). Also, the portable player 26 can reproduce the music contents (Listen) and the moving images (Watch).

The assignment of the activities to the respective source devices in the activity table may be stored in advance, or may be set by the user when the source device is connected.

When the user reproduces the content (when the user selects the contents to be reproduced), first such user selects the activity. The AV receiver 1 selects the source devices, which can reproduce the selected activity respectively, by referring to the activity table, and displays these source devices on the TV 3. The user selects the desired source device out of the displayed source devices. In response to this, the AV receiver 1 extracts the contents, which have the previously selected activity, out of the contents that the selected source device can reproduce (store therein), and displays the contents. When the user selects the desired content from the displayed contents, the AV receiver 1 reproduces the content (controls the source device to reproduce the content).

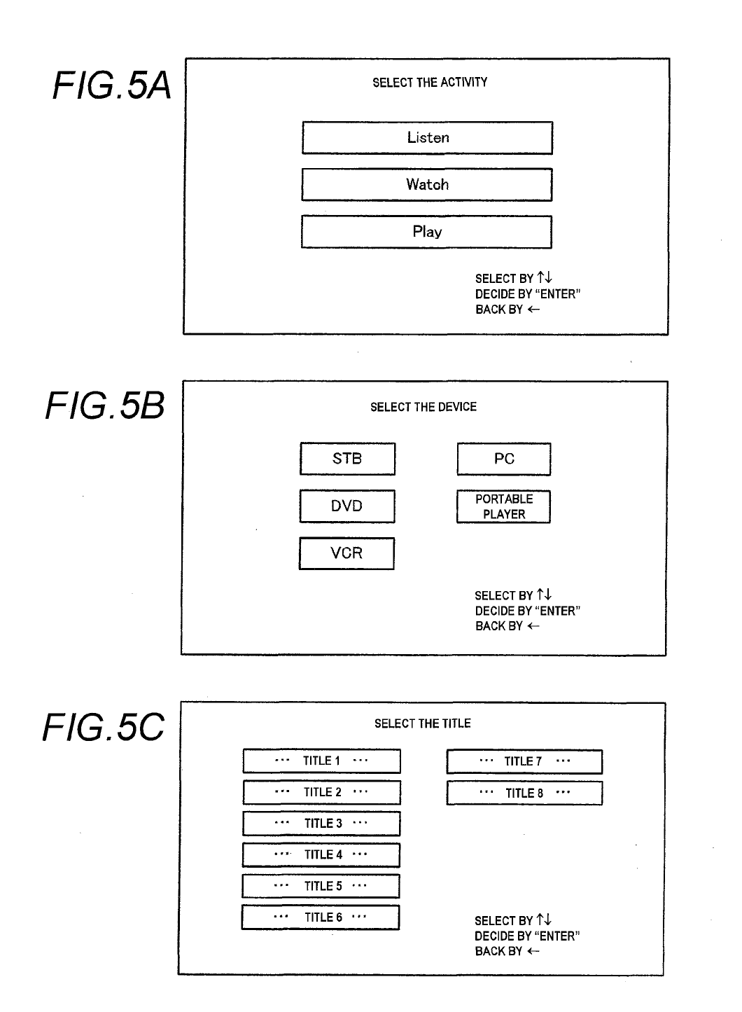

FIG. 4 is a flowchart showing an operation when the control unit 10 starts the reproduction of the contents. FIGS. 5A to 5C show a display example of the screen of the TV 3 at that time.

When the operation to select the content is executed by the user, first the AV receiver 1 switches the selector 14 to the control unit 10 (S1). This is because a following selecting screen should be displayed on the TV 3 as seen in FIGS. 5A to 5C. Then, the AV receiver 1 displays an activity selecting screen shown in FIG. 5A on the TV 3 (S2). Then, the user selects the activity in response to this display (S3). When the activity selecting operation is done, the control unit 10 extracts the source device that can reproduce the selected activity, by referring to an activity table in FIG. 3 (S4). Then, the control unit 10 causes the TV 3 to display an device selecting screen (see FIG. 5B) from which the user selects the extracted source device (S5).

The user selects the source device in response to this display (S6). When the user's operation for selecting the source device is done, the control unit 10 accesses the selected source device and then extracts the contents, which correspond to the previously selected activity, out of the contents that the selected source device can reproduce (S7).

In the case of the storage such as the USB memory 25, or the like, for example, the extracting process corresponds to the process in which the control unit 10 of the AV receiver 1 checks the stored files by accessing the storage via the peripheral device interface 16, and then extracts the contents corresponding to the designated activity from these files. Also, in the case of the intelligent device such as the portable player 26, this extracting process corresponds to the process in which the control unit 10 requests a list of the contents corresponding to the designated activity via the peripheral device interface 16, and then acquires a list of the corresponding contents under control of the destination device (portable player 26).

Then, the control unit 10 causes the TV 3 to display a content selecting screen (see FIG. 5C) (S8). When the user selects the content in response to this display (S9, S10:N), the AV receiver 1 switches the selector 14 to the selected device (S11), and then starts the reproduction of the selected contents (S12). This starting of content reproduction contains the operation that instructs the source device 2 to start the reproduction of the content, as well as the case where the AV receiver 1 itself reproduces the contents (e.g., reads the MPEG2 file and decodes it).

In contrast, if the user does not select the contents in the selecting operation in S9, but selects a “Return” operation (S10:Y), the process goes back to the displaying operation of the source device selecting screen (S5).

In this embodiment, the AV receiver 1 is illustrated as the audio/video content reproducing apparatus. But the particular configuration of the Audio/video content reproducing apparatus is not limited to the AV receiver.

### Modified Example

In the above-mentioned embodiment, when the control unit 10 starts the reproduction of the content, it is required to select the activity as in FIG. 5A, to select the source device as in FIG. 5B, and to select the content as in FIG. 5C. However, the present invention is not limited thereto. For example, a process of selecting the source device may be omitted.

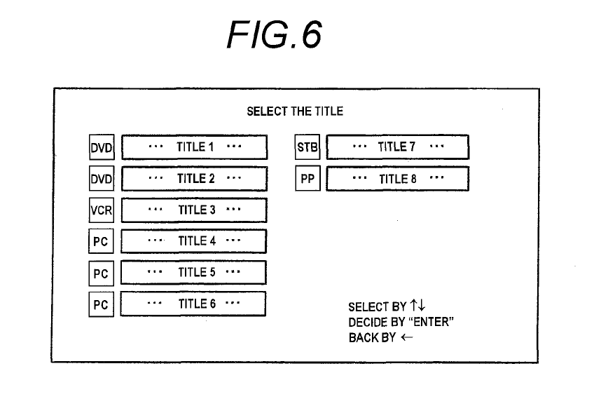

In the modified example, when the user selects an activity out of the displayed activities shown in FIG. 5A, the control unit 10 accesses the source devices that can reproduce the selected activity and then extracts the contents, which correspond to the previously selected activity. The control unit 10 causes the TV 3 to display a content selecting screen as shown in FIG. 6 directly without displaying the source device selecting screen. In this case, the selectable contents and the icons of the source devices corresponding to the respective selectable contents are displayed on the content selecting screen as shown in FIG. 6. Alternatively, the content selecting screen shown in FIG. 5C may be displayed after selecting the activity if it is not necessary to display the icons of the source devices.

What is claimed is:

1. An audio/video content reproducing apparatus, comprising:
a plurality of connecting sections to be connected to respective source devices, each device including a content reproducing section for reproducing at least a part of plural types of contents whose watching/listening modes are different from each other,
a watching/listening mode table for storing the watching/listening modes of the contents that the respective source devices can reproduce;
a watching/listening mode selecting section that is configured to accept the user's choice of the watching/listening mode;
a source device extracting section that is configured to extract at least one source device that can reproduce the contents in the selected watching/listening mode, with reference to the watching/listening mode table;
a source device selecting section that is configured to accept the user's choice of the source device out of the at least one extracted source device; and
a content reproducing section that is configured to output the content which the selected source device can reproduce in the selected watching/listening mode.

2. The audio/video content reproducing apparatus according to claim 1, wherein the content reproducing section includes:
a content extracting section that is configured to extract only the contents in the selected watching/listening mode out of the contents that the selected source device can reproduce; and
a content selecting section that is configured to accept the user's choice of the content out of the extracted contents.

3. The audio/video content reproducing apparatus according to claim 1, wherein the watching/listening modes include Listen mode, Watch mode and Play mode.

4. An audio/video content reproducing apparatus, comprising:
a plurality of connecting sections to be connected to respective source devices, each device including a content storing section for storing therein at least a part of plural types of contents whose watching/listening modes are different from each other,
a watching/listening mode table for storing the watching/listening modes of the contents stored in the respective source devices;
a watching/listening mode selecting section that is configured to accept the user's choice of the watching/listening mode;
a source device extracting section that is configured to extract at least one source device that stores the contents in the selected watching/listening mode, with reference to the watching/listening mode table;
a source device selecting section that is configured to accept the user's choice of the source device out of the at least one extracted source device; and
a content reproducing section that is configured to output the content stored in the selected source device in the selected watching/listening mode.

5. The audio/video content reproducing apparatus according to claim 4, wherein the content reproducing section includes:
a content extracting section that is configured to extract only the contents in the selected watching/listening mode out of the contents stored in the selected source device; and
a content selecting section that is configured to accept the user's choice of the content out of the extracted contents.

6. The audio/video content reproducing apparatus according to claim 4, wherein the watching/listening modes include Listen mode, Watch mode and Play mode.

7. An audio/video content reproducing apparatus, comprising:
a plurality of connecting sections to be connected to respective source devices, each device including a content reproducing section for reproducing at least a part of plural types of contents whose watching/listening modes are different from each other,
a watching/listening mode selecting section that is configured to accept the user's choice of the watching/listening mode;
a content extracting section that is configured to extract only the contents in the selected watching/listening mode out of the contents that the source devices can reproduce;
a content selecting section that is configured to accept the user's choice of the content out of the extracted contents; and
a content reproducing section that is configured to output the selected content in the selected watching/listening mode.

8. The audio/video content reproducing apparatus according to claim 7, wherein the watching/listening modes include Listen mode, Watch mode and Play mode.

9. An audio/video content reproducing apparatus, comprising:
a plurality of connecting sections to be connected to respective source devices, each device including a content storing section for storing therein at least a part of plural types of contents whose watching/listening modes are different from each other,
a watching/listening mode selecting section that is configured to accept the user's choice of the watching/listening mode;
a content extracting section that is configured to extract only the contents in the selected watching/listening mode out of the contents stored in the source devices;
a content selecting section that is configured to accept the user's choice of the content out of the extracted contents; and
a content reproducing section that is configured to output the selected content in the selected watching/listening mode.

10. The audio/video content reproducing apparatus according to claim 9, wherein the watching/listening modes include Listen mode, Watch mode and Play mode.
